(19) United States
(12) Patent Application Publication
(10) Pub. No.: US 2024/0190418 A1
(43) Pub. Date: Jun. 13, 2024

(54) ELECTRONIC CONTROL DEVICE AND METHOD FOR IMPROVING THE FUNCTIONAL SAFETY OF COOPERATIVE DRIVING MANEUVERS

(71) Applicant: Continental Automotive Technologies GmbH, Hannver (DE)

(72) Inventors: Sebastian Strunck, Niedernhausen (DE); Johannes Eck, Frankfurt am Main (DE); Thomas Grotendorst, Eschborn (DE)

(73) Assignee: Continental Automotive Technologies GmbH, Hannover (DE)

(21) Appl. No.: 18/286,946

(22) PCT Filed: Apr. 5, 2022
(86) PCT No.: PCT/DE2022/200066

§ 371 Date: Oct. 13, 2023

(30) Foreign Application Priority Data
Apr. 15, 2021 (DE) 10 2021 203 732.1

(51) Int. Cl. B60W 30/09; B60W 30/095; B60W 60/00; H04W 4/46

(52) U.S. Cl. CPC B60W 30/09; B60W 30/0956; B60W 60/0015; H04W 4/46; B60W 2556/35; B60W 2556/65

(57) ABSTRACT

Disclosed is an electronic control device of a first vehicle configured to carry out a method of:
checking a trajectory of the first vehicle, which trajectory is planned cooperatively with a second vehicle, with respect to a potential safety-critical traffic situation by means of a checking apparatus of the first vehicle on the basis of sensor information from at least one sensor of the first vehicle and/or on the basis of object data from a fusion of sensor information from at least two sensors of the first vehicle; and
outputting a signal for initiating a safety measure or executing the planned trajectory depending on a result of the check.

The disclosure relates to a method for improving the functional safety of cooperative driving maneuvers and to a corresponding electronic control device and to the use of the device.

Cooperative driving is based on the fact that vehicles exchange information. In the current discussion, for vehicle-to-X (V2X) communication, this primarily involves dynamic object data based on sensor information and maneuver/trajectory information. If a trajectory or a sequence of maneuvers has been calculated as a result of cooperative coordination, the sensor-based basis of the calculations is usually already comparatively old because the individual delays add up to form a delay chain.

This is intended to be illustrated on the basis of the following example of a delay chain from the perspective of a first vehicle. In this case, a second vehicle creates V2X messages from sensor-based data and from the ego maneuver planning, wherein it is assumed for this purpose that the second vehicle has not initially used any external trajectories in the ego planning. The first vehicle takes the data received with the V2X message as a basis for the ego planning of a maneuver. The numbers are assumed values and are only intended to demonstrate the concatenation:
second vehicle: creation of object data from sensor information: do2=100 ms
second vehicle: fusion of the object data of a plurality of sensors: df2=100 ms
second vehicle: maneuver planning: dm2=100 ms
second vehicle: V2X communication of the result of the maneuver planning: dc2=70 ms
first vehicle: creation of object data from sensor information: do1=100 ms
first vehicle: fusion of the received object data of the first vehicle and the object data of the second vehicle: df1_2=100 ms
first vehicle: maneuver planning: dm1=100 ms

The data are generated with the aid of an environment sensor system for capturing the environment of a vehicle (do) and the data from a plurality of sensors, in particular sensors overlapping in the capture region, are fused (df) and an object list is generated, in the case of which an entry exists in the object list for each real object. The data of the object list can then be transmitted to other vehicles using a cooperative perception message (CPM), in particular using vehicle-to-X communication (dc2). The object list is received by the second vehicle and has to be brought in line with the sensor data from the sensors of the second vehicle, from which the further fusion step (df1_2) results. The maneuver planning then takes place by means of a corresponding computing apparatus in the second vehicle (dm1).

The delay chain, starting from the sensor data ascertained by the first vehicle, for example as a cooperative perception message, up to the planned trajectory in the second vehicle, therefore results as:

do2+df2+dc2+df1_2+dm1=470 ms

The delay chain of the external trajectory results as:
do2+df2+dm2+dc2+dm1=470 ms

In this case, delays for example as a result of motor actuation or the actuator system or the driver reaction, etc. have not yet been taken into account.

In this example, the basis for a decision is therefore based on data that are at least approximately 500 ms old. Within this period of time, a vehicle at 50 km/h, which is usually permitted in urban areas, covers a distance of almost 7 m, which can be critical to safety for a pedestrian suddenly entering the road being used.

Planned trajectories to be driven by road users are in the future expected to be exchanged between the road users using maneuver coordination messages (MCMs). By way of example, the trajectories can be based on an environment model that is composed of ego sensor data and/or external sensor data that have been provided by means of a CPM as already described, for example. As soon as the trajectories created by maneuver planning have been calculated and have arrived at the receiver, the sensor data on which the maneuver planning is based and the trajectory resulting therefrom are already outdated on account of the delay chain independently of a coordination process, which goes beyond this, of the communicating road users. In particular, changes in the traffic situation or in the environment that occur within the delay time can lead to a received trajectory possibly no longer being drivable. Maneuver planning that takes these received trajectories into account can accordingly be erroneous.

As a result, it is possible for a corresponding trajectory transmitted from a first vehicle to be used as a basis for maneuver planning of a second vehicle receiving the trajectory and, on the basis thereof, for an erroneous trajectory to be calculated for the second vehicle. If replanning has to be subsequently carried out in some circumstances, the trajectory, which is transmitted from the second vehicle and afflicted with latency, is in turn used by the first vehicle. It is therefore possibly not possible to ascertain a collision-free result within the conventionally short time provided for maneuver planning, as a result of which the traffic safety of the road users involved, but also further road users, who are only indirectly involved, may be compromised.

The object of the invention is to improve the functional safety for cooperative driving maneuvers.

This object is achieved by the subjects of the independent claims. Advantageous configurations can be taken from the subclaims, for example. The content of the claims is incorporated in the content of the description by express reference.

According to a first aspect, a method to be carried out by an electronic control device of a first vehicle, and in particular for ensuring the functional safety for cooperative driving maneuvers of vehicles is described, having the steps of:
checking a trajectory of the first vehicle, which trajectory is planned cooperatively with a second vehicle, with respect to a potential safety-critical traffic situation by means of a checking apparatus of the first vehicle on the basis of sensor information from at least one sensor of the first vehicle (do1) and/or on the basis of object data from a fusion of sensor information from at least two sensors of the first vehicle (do1+df1); and
outputting a signal for initiating a safety measure or executing the planned trajectory depending on a result of the check.

In principle, sensor information provided by a sensor can already be present as object data.

The designations between parentheses correspond to the delays used in the introductory part of the description, wherein these are only intended to serve for easier understanding and do not constitute a limitation of the subject matter for which protection is sought.

According to at least one embodiment, the planned trajectory is checked by means of the checking apparatus of the first vehicle on the basis of data for which a delay chain does not comprise any delay as a result of:
a creation of object data from sensor information from at least one sensor of the second vehicle by the second vehicle (do2), or
any temporal delays as a result of a fusion of object data from a plurality of sensors of the second vehicle (df2), or
any maneuver planning by the second vehicle (dm2), or
any vehicle-to-X communication (dc2) of the result of the maneuver planning or fused object data, or
any fusion of the received fused object data of the second vehicle and of object data (df1_2) created from sensor information from at least one sensor of the first vehicle, or
any maneuver planning by the first vehicle (dm1).

The invention is based on the concept of ensuring the safeguarding of the journey of the first vehicle in the course of cooperative maneuver planning with a time horizon that could, in an improved way, also allow a corresponding reaction, in such a way that a trajectory of the first vehicle, which trajectory is cooperatively coordinated between the first vehicle and the second vehicle, but is afflicted with latency, is verified by means of a checking apparatus of the first vehicle, in particular to describe a planned distance to be driven over a defined time, and only data for which a time delay between capturing and utilizing the data is reduced to be as low as possible are used. Depending on a result of this check, a signal for initiating safety measures can be output, for example if the check shows the threat or existence of a safety-critical situation upon execution of the trajectory. The cooperatively planned trajectory is in particular calculated by a computing apparatus of the first vehicle on the basis of information exchanged with the second vehicle, for example in the course of a cooperative maneuver planning method. Expediently, the second vehicle can also calculate a trajectory to be driven by the second vehicle on the basis of the information exchanged in the course of the cooperative maneuver planning method. The checking by the checking apparatus of the first vehicle can accordingly be preceded by provision of the planned trajectory of the first vehicle by a trajectory planning apparatus of the first vehicle and capturing of the planned trajectory by the checking apparatus of the first vehicle.

A safety-critical traffic situation is in particular a risk of a collision with the second road user and/or a further road user and/or another obstacle if the trajectory is executed as planned.

The data used are therefore not affected by latencies in particular as a result of the creation of object data from sensor information from at least one sensor of the second vehicle by the second vehicle (do2) and the fusion of object data from a plurality of sensors of the first vehicle (df2) and maneuver planning by the first vehicle (dm2) and vehicle-to-X communication (dc2) of the result of the maneuver planning or fused object data and fusion of the received fused object data of the second vehicle and of the created object data of the first vehicle (df1) and maneuver planning by the second vehicle (dm1).

The principle can also be used for exclusively local maneuver planning that would involve comparatively long computation on hardware that is comparatively computationally weak. In this case, according to one embodiment, the planned trajectory would be checked with respect to a safety-critical traffic situation by means of a checking apparatus of the first vehicle on the basis of object data from a fusion of sensor information from at least one sensor of the first vehicle (do1+df1).

According to one development, the planned trajectory is a planned trajectory that has already been cooperatively coordinated between the first vehicle and the second vehicle, wherein the trajectory in particular takes into account or comprises information of a driving maneuver planned between the first vehicle and the second vehicle. By way of example, in this context, a trajectory can therefore also define interventions in the driving dynamics, for example at a defined point or after a planned distance traveled. It is therefore possible that steps for cooperative maneuver planning between the first vehicle and the second vehicle in order to determine the planned trajectory have already taken place in advance. A cooperative exchange of, for example, object information and/or information relating to the trajectories is effected in particular by means of vehicle-to-X communication.

According to at least one embodiment, the planned trajectory of the first vehicle is checked by means of the checking apparatus of the first vehicle on the basis of data for which the delay chain is determined by a delay as a result of data processing in particular essentially by a creation of object data from sensor information from at least one sensor of the first vehicle by the first vehicle (do1), or by a delay as a result of data processing by a creation of object data from sensor information from at least one sensor of the first vehicle by the first vehicle and a fusion of the received object data of the second vehicle and the created object data of the first vehicle by the first vehicle (do1+df1). The use of the term “essentially” appears appropriate in view of the fact that, in principle, further delays can be possible.

According to at least one embodiment, the trajectory of the first vehicle is therefore checked on the basis of data for which the delay chain furthermore does not comprise any delay as a result of data processing by a fusion of the object data from sensor information from at least one sensor of the first vehicle by the first vehicle (df1).

The first vehicle can therefore react, and possibly take necessary measures considerably more quickly, as a result of the shorter delay in the safety-relevant planning level. Road users for which sudden changes in direction are not unusual are therefore in particular better protected.

According to at least one embodiment, the at least one sensor of the first vehicle, and/or a section of a capture region of the at least one sensor of the first vehicle, which is/are assessed as relevant for the planned trajectory is/are selected from a plurality of sensors of the first vehicle to create the object data (df1). The object data obtained in such a targeted manner can accordingly be used to check the planned trajectory for safety-critical traffic situations. The planned trajectory can therefore in particular be double-checked and possibly adjusted again by a current sensor-based environment model. In particular, the sensor or sensors or environment region of the environment model of the first vehicle that allows/allow the path of the planned trajectory to be at least partially, in particular completely, captured is/are selected. If the path of the planned trajectory has only been partially captured, the part of the path of the trajectory that was not previously captured can be checked in a further step.

According to at least one embodiment, a signal for initiating a safety measure is output if a potentially safety-critical traffic situation is identified during the check of the planned trajectory.

According to at least one embodiment, a signal for executing the planned trajectory is output if no potentially safety-critical traffic situation is identified during the check of the planned trajectory.

According to at least one embodiment, replanning of the planned trajectory, for example an evasive maneuver, is carried out according to one development, and/or emergency braking and/or a minimum-risk maneuver (MRM), can be provided. The fundamental aim of initiating the safety measure is to avoid or eliminate the safety-critical traffic situation. The signal for initiating a safety measure is in particular output by means of a signal interface to a corresponding vehicle device for executing the safety measure.

According to at least one embodiment, in the situation in which the delay chain should essentially only consist of the creation of object data from sensor information of the second vehicle and the fusion of the received object data of the first vehicle and the object data of the second vehicle (do1+df1), the objects are fused in a first step and the collision check is carried out in a second step. Therefore, the collision check no longer needs to be carried out for the sensor information from each individual sensor.

A vehicle may be a motor vehicle, in particular a passenger motor vehicle, a heavy goods vehicle, a motorcycle, an electric motor vehicle or a hybrid motor vehicle, a watercraft or an aircraft.

According to a second aspect, an electronic control device for a first vehicle is described, comprising:
a checking apparatus, configured to carry out a check of a planned trajectory of the first vehicle with respect to a potential safety-critical traffic situation of the first vehicle on the basis of sensor information from at least one sensor of the first vehicle (do1) and/or on the basis of object data from a fusion of sensor information from at least two sensors of the first vehicle (do1+df1), wherein the planned trajectory was received by means of a vehicle-to-X communication device of the first vehicle; and
a signal interface, configured to output a signal for initiating a safety measure or executing the planned trajectory depending on a result of the check.

According to a further aspect, the device is designed to carry out a method as claimed in at least one of the preceding embodiments.

A computing unit may be any apparatus that is designed to process at least one of the signals mentioned. By way of example, the computing unit may be a processor, a digital signal processor, a central processing unit (CPU), a multi-purpose processor (MPP), or the like.

In one development of the specified device, the specified device has a memory and a processor. In this case, the specified method is stored in the memory in the form of a computer program, and the processor is provided for carrying out the method when the computer program is loaded into the processor from the memory.

According to a further aspect of the invention, a computer program comprises program code means in order to perform all the steps of one of the specified methods when the computer program is executed on a computer or one of the specified devices.

According to a further aspect of the invention, a computer program product contains a program code that is stored on a computer-readable data carrier and that, when executed on a data processing apparatus, carries out one of the specified methods.

Some particularly advantageous configurations of the invention are specified in the dependent claims. Further preferred embodiments also emerge from the following description of exemplary embodiments on the basis of figures.

In each case, schematically:

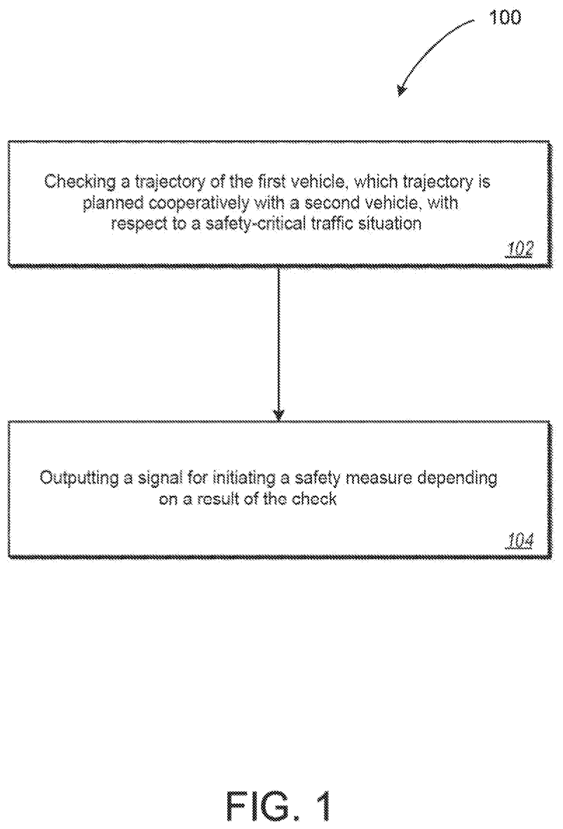

FIG. 1 shows a flow chart of an embodiment of the method for improving the functional safety of cooperative driving maneuvers, and

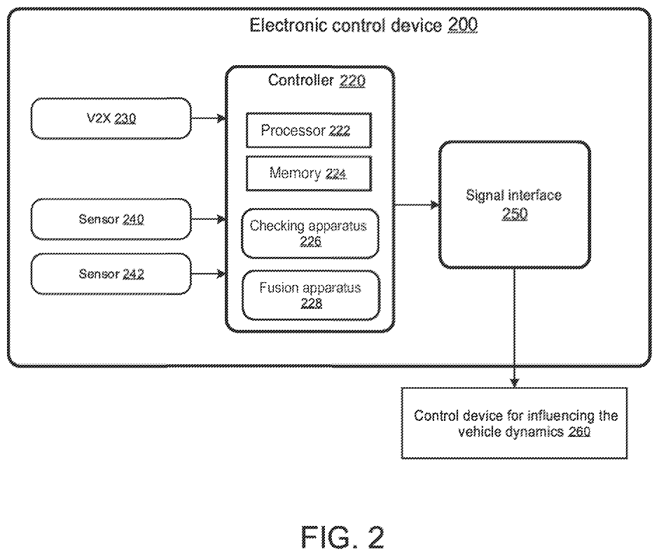

FIG. 2 shows an embodiment of the electronic control device.

FIG. 1 shows an embodiment of the method 100 to be carried out by an electronic control device of a first vehicle. In a step 102, a trajectory of the first vehicle is checked, which trajectory is planned cooperatively with a second vehicle, with respect to a potential safety-critical traffic situation by means of a checking apparatus of the first vehicle on the basis of sensor information from at least one sensor of the first vehicle (do1) and/or on the basis of object data from a fusion of sensor information from at least one sensor of the first vehicle (do1+df1).

Depending on a result of the check, in a step 104, furthermore, a signal for initiating a safety measure is output or the planned trajectory is executed.

FIG. 2 shows an embodiment of the electronic control device 200 for a first vehicle.

The control device 200 comprises a checking apparatus 226, which is configured to carry out a check of a planned trajectory of the first vehicle with respect to a potential safety-critical traffic situation of the first vehicle on the basis of sensor information from at least one sensor 240, 242 of the first vehicle (do1) and/or on the basis of object data from a fusion of sensor information from at least two sensors 240, 242 of the first vehicle (do1+df1). In this case, the planned trajectory was received from a second vehicle by means of a vehicle-to-X communication device 230. The electronic control device 200 can comprise a fusion apparatus 228 for the fusion of the sensor information from a plurality of sensors 240, 242. By way of example, the checking apparatus 228 is comprised by a controller 220, wherein the controller can have a processor 222 and a data memory 224.

The control device 200 furthermore comprises a signal interface 250, configured to output a signal for initiating a safety measure or executing the planned trajectory depending on a result of the check. By way of example, the output to a control device 260 comprised by the first vehicle is effected to influence the vehicle dynamics of the first vehicle.

If it is found in the course of the proceedings that a feature or a group of features is not absolutely necessary, then the applicant aspires right now to a wording of at least one independent claim that no longer has the feature or the group of features. This may be, for example, a subcombination of a claim present on the filing date or a subcombination of a claim present on the filing date that is restricted by further features. Claims or combinations of features of this kind requiring rewording are intended to be understood as also covered by the disclosure of this application.

It should also be pointed out that refinements, features and variants of the invention which are described in the various embodiments or exemplary embodiments and/or shown in the figures may be combined with one another in any desired manner. Single or multiple features are interchangeable with one another in any desired manner. Combinations of features arising therefrom are intended to be understood as also covered by the disclosure of this application.

Back-references in dependent claims are not intended to be understood as a relinquishment of the attainment of independent substantive protection for the features of the back-referenced dependent claims. These features may also be combined with other features in any desired manner.

Features that are only disclosed in the description or features that are only disclosed in the description or in a claim in conjunction with other features may in principle be of independent significance essential to the invention. They may therefore also be individually included in claims for the purpose of delimitation from the prior art.

In general, it should be pointed out that vehicle-to-X communication is understood to mean, in particular, a direct communication between vehicles and/or between vehicles and infrastructure apparatuses. For example, it may therefore include vehicle-to-vehicle communication or vehicle-to-infrastructure communication. Where this application refers to a communication between vehicles, said communication may fundamentally take place as part of a vehicle-to-vehicle communication, for example, which is typically effected without switching by a mobile radio network or a similar external infrastructure and which must therefore be distinguished from other solutions based on a mobile radio network, for example. By way of example, a vehicle-to-X communication may be implemented using the IEEE 802.11p or IEEE 1609.4 standard. A vehicle-to-X communication may also be referred to as C2X communication or V2X communication. The sub-domains may be referred to as C2C (car-to-car), V2V (vehicle-to-vehicle) or C21 (car-to-infrastructure), V21 (vehicle-to-infrastructure). However, the invention does not explicitly exclude vehicle-to-X communication with switching via a mobile radio network, for example.

1. A method to be carried out by an electronic control device of a first vehicle, comprising the steps of:
checking a trajectory of the first vehicle, which trajectory is planned cooperatively with a second vehicle, with respect to a potential safety-critical traffic situation, by a checking apparatus of the first vehicle based on sensor information from at least one sensor of the first vehicle and/or based on object data from a fusion of sensor information from at least two sensors of the first vehicle; and
outputting a signal for initiating a safety measure or executing the planned trajectory depending on a result of the check.

2. The method as claimed in claim 1, wherein the planned trajectory is checked by the checking apparatus of the first vehicle based on data for which a delay chain does not comprise any creation of object data from sensor information from at least one sensor of the second vehicle by the second vehicle or any temporal delays as a result of a fusion of object data from a plurality of sensors of the second vehicle or any maneuver planning by the second vehicle or any vehicle-to-X communication of a result of the maneuver planning or fused object data or any fusion of received fused object data of the second vehicle and of object data created from sensor information from at least one sensor of the first vehicle or any maneuver planning by the first vehicle.

3. The method as claimed in claim 1, wherein the trajectory of the first vehicle is checked based on data for which a delay chain furthermore does not comprise any delay as a result of data processing by a fusion of the object data from sensor information from at least one sensor of the first vehicle by the first vehicle.

4. The method as claimed in claim 1, wherein the at least one sensor of the first vehicle, and/or a section of a capture region of the at least one sensor of the first vehicle, which is assessed as relevant for the planned trajectory is selected from a plurality of sensors of the first vehicle to create the object data.

5. The method as claimed in claim 1, wherein a signal for executing the planned trajectory is output if no potentially safety-critical traffic situation is identified during the checking of the planned trajectory.

6. The method as claimed in claim 1, wherein a signal for initiating a safety measure is output if a potentially safety-critical traffic situation is identified during the checking of the planned trajectory.

7. The method as claimed in claim 1, wherein replanning of the planned trajectory, an evasive maneuver, and/or emergency braking and/or a minimum-risk maneuver, can be provided as a safety measure.

8. An electronic control device for a first vehicle, comprising:
a checking apparatus, configured to carry out a check of a planned trajectory of the first vehicle with respect to a potential safety-critical traffic situation of the first vehicle based on sensor information from at least one sensor of the first vehicle and/or based on object data from a fusion of sensor information from at least two sensors of the first vehicle, wherein the planned trajectory was received via a vehicle-to-X communication device of the first vehicle; and
a signal interface, configured to output a signal for initiating a safety measure or executing the planned trajectory depending on a result of the check.

9. The electronic control device as claimed in claim 8, configured to carry out a method comprising:
checking a trajectory of the first vehicle, which trajectory is planned cooperatively with a second vehicle, with respect to a potential safety-critical traffic situation, by a checking apparatus of the first vehicle based on sensor information from at least one sensor of the first vehicle and/or based on object data from a fusion of sensor information from at least two sensors of the first vehicle; and
outputting a signal for initiating a safety measure or executing the planned trajectory depending on a result of the check.

10. Using the electronic control device claimed in claim 8.

11. Using the electronic control device claimed in claim 9.

12. The electronic control device as claimed in claim 9, wherein the planned trajectory is checked by the checking apparatus of the first vehicle based on data for which a delay chain does not comprise any creation of object data from sensor information from at least one sensor of the second vehicle by the second vehicle or any temporal delays as a result of a fusion of object data from a plurality of sensors of the second vehicle or any maneuver planning by the second vehicle or any vehicle-to-X communication of a result of the maneuver planning or fused object data or any fusion of received fused object data of the second vehicle and of object data created from sensor information from at least one sensor of the first vehicle or any maneuver planning by the first vehicle.

13. The electronic control device as claimed in claim 9, wherein the trajectory of the first vehicle is checked based on data for which a delay chain furthermore does not comprise any delay as a result of data processing by a fusion of the object data from sensor information from at least one sensor of the first vehicle by the first vehicle.

14. The electronic control device as claimed in claim 9, wherein the at least one sensor of the first vehicle, and/or a section of a capture region of the at least one sensor of the first vehicle, which is assessed as relevant for the planned trajectory is selected from a plurality of sensors of the first vehicle to create the object data.

15. The electronic control device as claimed in claim 9, wherein a signal for executing the planned trajectory is output if no potentially safety-critical traffic situation is identified during the checking of the planned trajectory.

16. The electronic control device as claimed in claim 9, wherein a signal for initiating a safety measure is output if a potentially safety-critical traffic situation is identified during the checking of the planned trajectory.

17. The electronic control device as claimed in claim 9, wherein replanning of the planned trajectory, an evasive maneuver, and/or emergency braking and/or a minimum-risk maneuver, can be provided as a safety measure.
